(19) United States
(12) Patent Application Publication
(10) Pub. No.: US 2008/0035151 A1
(43) Pub. Date: Feb. 14, 2008

(54) Mouth-held breathing air filter

(76) Inventor: Gerardo Solorzano-Garcia, Las Vegas, NV (US)

Correspondence Address: SUNG I. OH, PROFESSIONAL LAW CORPORATION, 710 QUAIL VALLEY LANE, WEST COVINA, CA, 91791, US

(21) Appl. No.: 11/500,743

(22) Filed: Aug. 8, 2006

(51) Int. Cl. A62B 23/02; A62B 7/10

(52) U.S. Cl. 128/206.11; 128/205.29

(57) ABSTRACT

An air filter that a user places in his mouth when necessary. The filter is in the shape of a plug and has inlet air ports defined therein with the air passing through filter media before passing out of outlet ports which are located inside the user's mouth when the filter is in use. The filter can be worn around a user's neck to be readily available when needed.

### TECHNICAL FIELD OF THE INVENTION

The present invention relates to the general art of filters, and to the particular field of filters used to purify breathable air.

### BACKGROUND OF THE INVENTION

In the past, respiratory devices for filtering and removing noxious material and fumes from atmospheric air have generally included a screen or filter material which when attached to the face of the user covers the mouth and nose of the user. Other respiratory devices have included a complex canister or container combination containing catalysts and filters which also must be worn on the face of the user. When desired, such devices have been provided with face masks, nose clips, goggles and complex tubing connecting the filter containers and the face mask.

Respiratory protective devices have been in use in workplace and emergency type settings for many years. While these devices are very effective for those professionals that wear them, their bulky design and high expense can be a deterrent to the private individual. Furthermore, workers may forego the use of mask type respirators for periods of short term exposure where the time involved in retrieving, fitting, and replacing the respirator is thought to outweigh the potential harm to the employee. Unfortunately, the uninformed worker can experience lasting detrimental effects to his health from even short-term exposure to certain airborne contaminants.

Therefore, such devices have found only limited application as occupational safeguards because they are difficult to use, are generally uncomfortable to wear and bulky in appearance. Moreover, such devices are expensive to manufacture, unsightly to the wearer and have often encountered problems wherein the saliva of the user penetrates the interior respirator device to destroy the efficiency thereof.

Furthermore, the threat of airborne contaminants to those who do not regularly encounter such particles, including chemical, inorganic, and biological contaminants, is becoming more common. With city overcrowding and ever decreasing living spaces, contact with other people is a fact of daily life. Many individuals are likely to have close contact with sick persons on a daily basis. In the event of an emergency, an individual may not have time to retrieve a large mask type respirator from storage that could effectively filter inhaled air. Further, a person may find himself in a situation where access to a mask type respirator is impossible. By the time such person is able to retreat from the infected area, he may have already inhaled harmful contaminants.

Still further, some workers, such as gardeners and the like, may come into contact with airborne contaminants on a periodic, yet unpredictable, basis such as when a lawn or garden is being serviced with chemicals. At other times, the air is safely breathable. Filtration is therefore, only required at certain times. This will require a worker to stop work to place a filter. This is not only annoying to the worker, but is also time consuming and costly to the employer.

### SUMMARY OF THE INVENTION

The above-discussed disadvantages of the prior art are overcome by an air filter that a user places in his mouth when necessary. The filter is in the shape of a plug and has inlet air ports defined therein with the air passing through filter media before passing out of outlet ports which are located inside the user's mouth when the filter is in use. The filter can include a lanyard or the like so it can be worn around the user's neck to be readily available when needed.

The intra-oral filter embodying the present invention is easy and convenient to use and will permit a user to have the filter available whenever necessary.

Other systems, methods, features, and advantages of the invention will be, or will become, apparent to one with skill in the art upon examination of the following figures and detailed description. It is intended that all such additional systems, methods, features, and advantages be included within this description, be within the scope of the invention, and be protected by the following claims.

### BRIEF DESCRIPTION OF THE DRAWING FIGURES

The invention can be better understood with reference to the following drawings and description. The components in the figures are not necessarily to scale, emphasis instead being placed upon illustrating the principles of the invention. Moreover, in the figures, like referenced numerals designate corresponding parts throughout the different views.

FIG. 1 is a perspective view of a breathable air filter embodying the present invention.

FIG. 2 is a view taken along line 2-2 of FIG. 1.

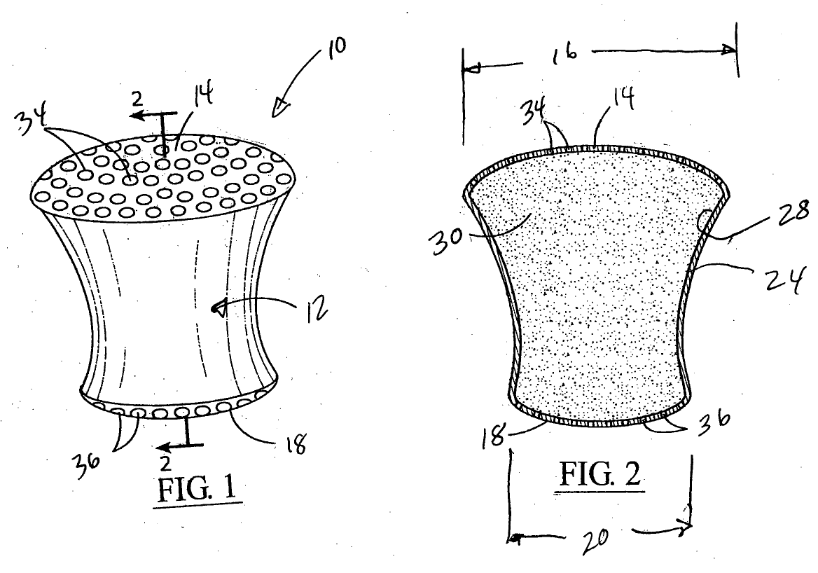

### DETAILED DESCRIPTION OF THE INVENTION

Referring to the figures, it can be understood that the present invention is embodied in a breathable air filter 10 which comprises a body 12 which is formed of material, such as plastic or the like, that is suitable for use in a user's mouth. The body includes a first end 14 which is an inlet end when the body is in use, the first end having an outer dimension 16, and a second end 18 which is an outlet end when the body is in use. The second end has an outer dimension 20. Outer dimension 20 of the second end is larger than outer dimension 16 of the first end.

A sidewall 24 connects first end 14 to second end 18 and is concave in shape. An interior chamber 28 is defined inside the body, and filter media 30 is located in the interior chamber and fills the entire interior chamber. A plurality of air inlet ports 34 are defined through the inlet end of the body and are fluidically connected to the filter media. A plurality of air outlet ports 36 defined through the outlet end of the body and are fluidically connected to the filter media so air entering the body through the inlet ports must pass through the filter media before passing through the outlet ports whereby the air is filtered during passage through the body.

The filter can be supported on a lanyard or the like which is worn around a user's neck until needed. The filter is then used by placing body 12 in a user's mouth with air inlet ports 34 located outside the wearer's mouth and air outlet ports 36 located inside the user's mouth. The user clasps the body by placing his or her teeth against the sidewall of the body, closes his or her lips against the body and inhales to draw air through the body via the air outlet ports and causes air to enter the body through the air inlet ports. Air entering the body via the inlet ports is forced to pass through the filter media before passing through the outlet ports and is filtered during passage through the body.

While various embodiments of the invention have been described, it will be apparent to those of ordinary skill in the art that many more embodiments and implementations are possible within the scope of this invention. Accordingly, the invention is not to be restricted except in light of the attached claims and their equivalents.

What is claimed is:

1. A breathable air filter comprising:
A) a body which includes
(1) a first end which is an inlet end when the body is in use, the first end having an outer dimension,
(2) a second end which is an outlet end when the body is in use, the second end having an outer dimension, the outer dimension of the second end being larger than the outer dimension of the first end,
(3) a sidewall which connects the first end to the second end, the sidewall being concave in shape, and
(4) an interior chamber defined inside the body;
B) filter media located in the interior chamber and filling the entire interior chamber;
C) a plurality of air inlet ports defined through the inlet end of the body and fluidically connected to the filter media;
D) a plurality of air outlet ports defined through the outlet end of the body and fluidically connected to the filter media so air entering the body through the inlet ports must pass through the filter media before passing through the outlet ports whereby the air is filtered during passage through the body.

2. A method of breathing filtered air comprising:
A) providing a body which includes a first end which is an inlet end when the body is in use, the first end having an outer dimension, a second end which is an outlet end when the body is in use, the second end having an outer dimension, the outer dimension of the second end being larger than the outer dimension of the first end, a sidewall which connects the first end to the second end, the sidewall being concave in shape, and an interior chamber defined inside the body, a filter media located in the interior chamber and filling the entire interior chamber, a plurality of air inlet ports defined through the inlet end of the body and fluidically connected to the filter media, and a plurality of air outlet ports defined through the outlet end of the body and fluidically connected to the filter media;
B) placing the body in a user's mouth with the air inlet ports located outside the wearer's mouth and the air outlet ports located inside the user's mouth;
C) drawing air through the body via the air outlet ports and causing air to enter the body through the air inlet ports; and
D) forcing air entering the body through the inlet ports to pass through the filter media before passing through the outlet ports and filtering the air during passage through the body.

3. The method defined in claim 2 further comprising holding the body in place by placing the user's teeth against the sidewall of the body adjacent to the outlet end of the body.

4. The method defined in claim 3 further comprising placing the lips of the user against the sidewall of the body.
